(19) United States
(12) Patent Application Publication
(10) Pub. No.: US 2026/0133370 A1
(43) Pub. Date: May 14, 2026

(54) Parallel Single Mode Ganged Optical Circuit Switch

(71) Applicant: Ciena Corporation, Hanover, MD (US)

(72) Inventors: David W. Boertjes, Nepean (CA); Michael Y. Frankel, Hallandale Beach, FL (US); Vladimir Pelekhaty, Baltimore, MD (US); Daniel Rivaud, Ottawa (CA)

(73) Assignee: Ciena Corporation, Hanover, MD (US)

(21) Appl. No.: 18/945,892

(22) Filed: Nov. 13, 2024

(51) Int. Cl. G02B 6/35

(52) U.S. Cl. CPC G02B 6/3546; G02B 6/3518

(57) ABSTRACT

A ganged optical circuit switch includes an input array and an output array each having a set of ports; a first switching plane and a second switching plane disposed between the input array and the output array, each having a plurality of switching elements; and one or more multiplexing lenses located between the input array and the output array, configured to perform angular multiplexing of a group of the set of ports where all channels from the group are on a single switching element of the plurality of switching elements. The group of the set of ports can correspond to a parallel single mode (PSM) optical transceiver, such that the angular multiplexing reduces the number of switching elements by a number of channels on the PSM optical transceiver.

### FIELD OF THE DISCLOSURE

The present disclosure relates generally to networking and computing. More particularly, the present disclosure relates to systems and methods for a parallel single mode (PSM) ganged optical circuit switch (OCS).

### BACKGROUND OF THE DISCLOSURE

A ganged optical circuit switch is a specialized type of optical switch designed to simultaneously switch multiple optical paths in a coordinated or “ganged” manner. These switches feature mechanically coupled switch elements that move together to ensure synchronized operation across all optical channels. The underlying technology can be implemented through various approaches, including MEMS (micro-electro-mechanical systems), moving fiber/waveguide arrangements, or beam-steering mechanisms. Parallel single mode (PSM) optical modules use multiple lanes of single-mode fiber to transmit data in parallel, enabling higher aggregate bandwidth compared to traditional single-lane solutions. These modules typically split a high-speed data stream into multiple lower-speed lanes, each transmitted over a dedicated single-mode fiber, before being recombined at the receiver. Example PSM implementations range from 2 to 16 parallel lanes (PSM2, PSM4, PSM8, PSM16). These variants serve different bandwidth needs across data centers, enterprise networks, telecommunications infrastructure, etc., offering flexible solutions for various speeds from 50G to 800G and beyond.

### BRIEF SUMMARY OF THE DISCLOSURE

The present disclosure relates to systems and methods for a parallel single mode (PSM) ganged optical circuit switch (OCS). Large-scale artificial intelligence (AI) and machine learning operations, particularly in training large language models (LLMs), face significant challenges in optical circuit switch (OCS) implementations. While hyperscalers (i.e., companies operating massive-scale data centers and cloud computing infrastructure) have adopted OCS technology in their datacenters and are exploring bi-directional single fiber transponders to reduce port usage, the current solutions face substantial limitations. The core issue revolves around port scaling: modern graphics processing unit (GPU) clusters, e.g., 72-GPU configurations (soon expanding to hundreds), require multiple 200 Gbps lanes per GPU, resulting in several Terabits per second of interconnect traffic. Current OCS technologies, including MEMS-based devices and liquid crystal (LC)-based solutions, typically offer only hundreds of ports (around 300×300), while planar Silicon (Si) Photonics implementations are limited to 64×64 ports. The emergence of PSM optics with up to 16 fibers will demand OCS systems with thousands of ports-a scale that exceeds current technological capabilities. While robotic patch panels can theoretically handle this port count by moving connectors with multiple fibers or multi-core fibers, they are impractically slow and bulky. Notably, there has not been a viable solution proposed for using PSM optics to address OCS port count limitations without physically moving fibers, creating a significant technological bottleneck in the development of high-performance AI training infrastructure.

As such, this disclosure addresses the port scaling challenges in optical circuit switches by leveraging the inherent architecture of PSM optics. This involves multiplexing multiple single-mode optical sources onto a single switching element within the OCS, fundamentally reducing the complexity and size of the switching matrix. In practical terms, when dealing with a PSM16 configuration (which uses 16 fiber pairs), this approach reduces the required number of switching elements by a factor of 16 compared to a traditional fully flexible OCS design. For example, in a system with 1024 ports, instead of requiring 1024×1024 switching elements, the multiplexed design would only need 64×64 switching elements-a substantial reduction in complexity. This optimization is particularly valuable for high-performance computing and AI/ML applications where large numbers of high-bandwidth connections (200 Gbps+ per lane) need to be dynamically routed. The design not only simplifies the OCS architecture but also makes it more practical to implement at the scale required for next-generation data center interconnects and supercomputer clusters, while maintaining the full functionality needed for PSM optical communications.

In an embodiment, a ganged optical circuit switch includes an input array and an output array each having a set of ports; a first switching plane and a second switching plane disposed between the input array and the output array, each having a plurality of switching elements; and one or more multiplexing lenses located between the input array and the output array, configured to perform angular multiplexing of a group of the set of ports where all channels from the group are on a single switching element of the plurality of switching elements. The input array and the output array can include the set of ports in rows and columns. In an embodiment, a row of the rows is angularly multiplexed onto the single switching element such that the row is switched to any of the rows on the output array. The switching elements can be micro-electro-mechanical systems (MEMS) mirrors. The channels from a given group are each switched via a given mirror of the MEMS mirrors.

The ganged optical circuit switch can further include a free space region between the input array and the output array with each of the channels traversing the free space region separate except when angularly multiplexed via a lens onto the single switching element. In an embodiment, the one or more multiplexing lenses include a first cylindrical lens, a second cylindrical lens, a third cylindrical lens, and a fourth cylindrical lens. The first cylindrical lens is located between the input array and the first switching plane; the second cylindrical lens and the third cylindrical lens are located between the first switching plane and the second switching plane; and the fourth cylindrical lens is located between the second switching plane and the output array. Each of the one or more multiplexing lenses can be an identical lens. The input array can be configured to perform a first stage of the angular multiplexing of the group, so that there is no lens between the input array and the first switching element.

In another embodiment, a method of operating a ganged optical circuit switch includes receiving a group of a set of ports at an input array; angularly multiplexing channels from the group of ports via one or more multiplexing lenses located between the input array and an output array; and switching the channels from the group of ports via single switching elements on a first switching plane and a second switching plane disposed between the input array and the output array, wherein each of the single switching elements is configured to switch all the channels together. The input array and the output array can include the set of ports in rows and columns. A row of the rows can be angularly multiplexed onto the single switching element such that the row is switched to any of the rows on the output array. In an embodiment, the switching elements are micro-electro-mechanical systems (MEMS) mirrors. The channels from a given group are each switched via a given mirror of the MEMS mirrors.

There can be a free space region between the input array and the output array with each of the channels traversing the free space region separate except when angularly multiplexed via a lens onto the single switching elements. In an embodiment, the one or more multiplexing lenses include a first cylindrical lens, a second cylindrical lens, a third cylindrical lens, and a fourth cylindrical lens. The first cylindrical lens is located between the input array and the first switching plane; the second cylindrical lens and the third cylindrical lens are located between the first switching plane and the second switching plane; and the fourth cylindrical lens is located between the second switching plane and the output array. Each of the one or more multiplexing lenses can be an identical lens. The input array can be configured to perform a first stage of the angular multiplexing of the group, so that there is no lens between the input array and the first switching element.

### BRIEF DESCRIPTION OF THE DRAWINGS

The present disclosure is detailed through various drawings, where like components or steps are indicated by identical reference numbers for clarity and consistency.

FIG. 1 illustrates an example PSM16 (16-lane parallel single mode) optical device.

FIGS. 2 to 5 illustrate various views of an example ganged OCS 20 utilizing angular multiplexing to combine multiple optical signals, such as from PSM optical transceivers.

FIG. 6 illustrates a system with an array, lens, and a switching element, with a different angular multiplexing arrangement from the OCS from FIGS. 2 to 5.

FIG. 7 illustrates a system with circular lens for angular multiplexing of vertically and horizontally arranged inputs/outputs.

FIG. 8 illustrates a diagram of an implementation of a curved input array output array.

FIG. 9 illustrates a flowchart of a process of operating a ganged optical circuit switch

### DETAILED DESCRIPTION OF THE DISCLOSURE

The present disclosure includes a PSM ganged OCS which employs an innovative approach by implementing angular multiplexing to combine multiple optical signals. This technique groups multiple input signals into a unified beam through precise angular arrangements, allowing a single switching element to manipulate multiple channels simultaneously. The angular multiplexing is achieved by launching each input beam at a specific angle into a propagation medium, which can be either a bulk optical material (such as specialized optical glass, fused silica, or other transparent materials with specific refractive indices) or a free-space environment (such as air, vacuum, or inert gases). The beams propagate through this medium while maintaining their distinct angular relationships, enabling them to be controlled as a single unit by the switching element. At the output, a corresponding demultiplexing arrangement separates the beams back into individual channels, preserving the original signal integrity. This approach is particularly efficient for PSM applications as it maintains the parallel nature of the signals while significantly reducing the complexity of the switching infrastructure. The design's versatility in medium choice (bulk or free-space) allows for optimization based on specific application requirements, such as insertion loss, crosstalk, and environmental stability considerations.

By grouping the multiple input signals, all PSM channels are switched together using a single switching element (i.e., pixel, port, mirror, etc.) thereby enabling a reduction of N in the number of switching elements required where N is the number of PSM channels. Again, using the PSM16 configuration (which uses 16 fiber pairs), this approach reduces the required number of switching elements by a factor of 16 compared to a traditional fully flexible OCS design. For example, in a system with 1024 ports, instead of requiring 1024×1024 switching elements, the ganged OCS design would only need 64×64 switching elements—a substantial reduction in complexity and one that is realizable with current technology.

### PSM

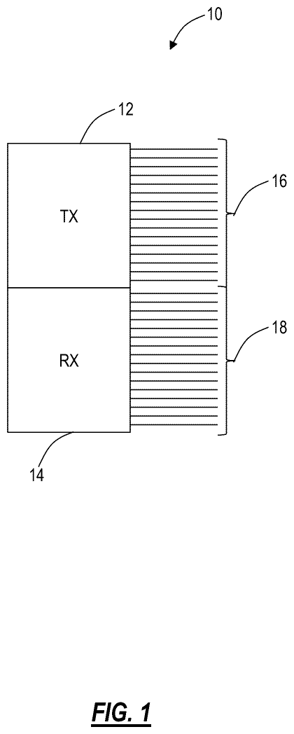

FIG. 1 illustrates an example PSM16 (16-lane parallel single mode) optical device 10. The PSM16 optical device 10 includes a transmitter (Tx) 12 and a receiver (Rx) 14, with components for implementation of parallel optical technology, utilizing 32 fibers total, namely 16 Tx fibers 16 and 16 Rx fibers 18. The Tx 12 and the Rx 14 include components to split high-speed data streams across these 16 parallel lanes. In current implementations, each lane typically operates at speeds of 50G or 100G per lane, enabling aggregate bandwidths of 800G to 1.6T, respectively. That is, the overall signal is 800G to 1.6T, but transmitted and received in parallel, lower-speed data streams. This parallel architecture is particularly valuable in applications requiring massive data throughput, such as AI/ML training clusters, high-performance computing environments, and next-generation data center interconnects. PSM16 modules maintain the long-distance transmission advantages of single-mode fiber while offering higher aggregate bandwidth compared to lower-lane-count alternatives like PSM4 or PSM8. Those skilled in the art will recognize the PSM16 optical device 10 is presented as an example, and other approaches are contemplated.

PSM and wavelength division multiplexing (WDM) represent two distinct approaches to achieving high-bandwidth optical transmission, each with unique advantages. PSM16 uses 16 parallel single-mode fibers per direction, providing simpler optical design and potentially lower latency since each lane operates at a native wavelength without the need for wavelength conversion or multiplexing/demultiplexing complexity. This parallel architecture offers better power efficiency and signal integrity compared to WDM solutions, as it avoids the thermal challenges and crosstalk issues associated with densely packed wavelengths. Additionally, PSM16 modules typically cost less to manufacture than equivalent-bandwidth WDM solutions since they do not require expensive wavelength-specific lasers and filters. However, the trade-off comes in fiber count-PSM16 requires 32 fibers (16 pairs) compared to WDM's ability to transmit multiple channels over a single fiber pair.

Note, in a data center application, the higher fiber count is not necessarily a disadvantage, but it is for optical circuit switching due to the significantly increased switching elements required. Now, the present disclosure notes that all parallel single-mode fibers are switched together in tandem with one another. So, to reduce switching elements, the ganged OCS described herein uses angular multiplexing so that all optical signals from the parallel single-mode fibers are switched via a same switching element.

### Ganged OCS

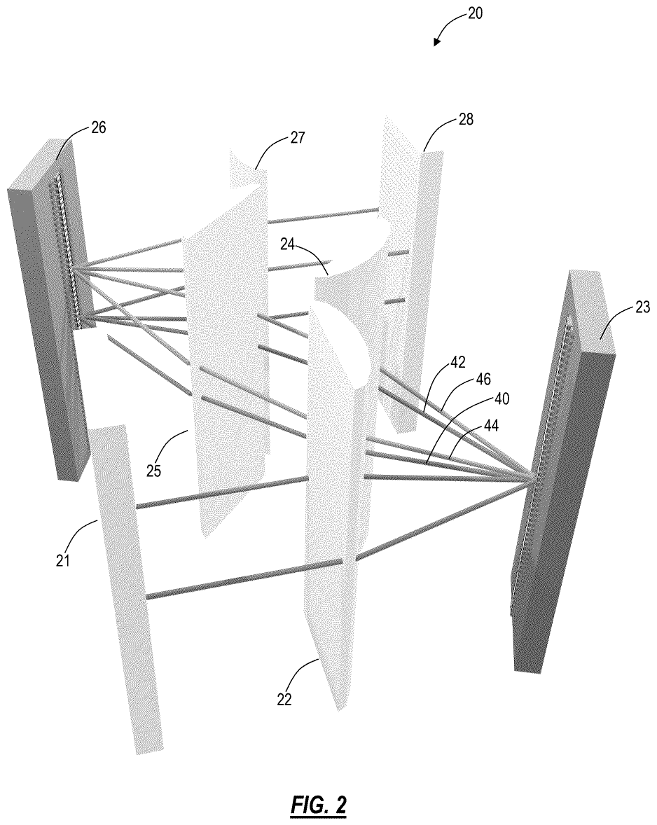

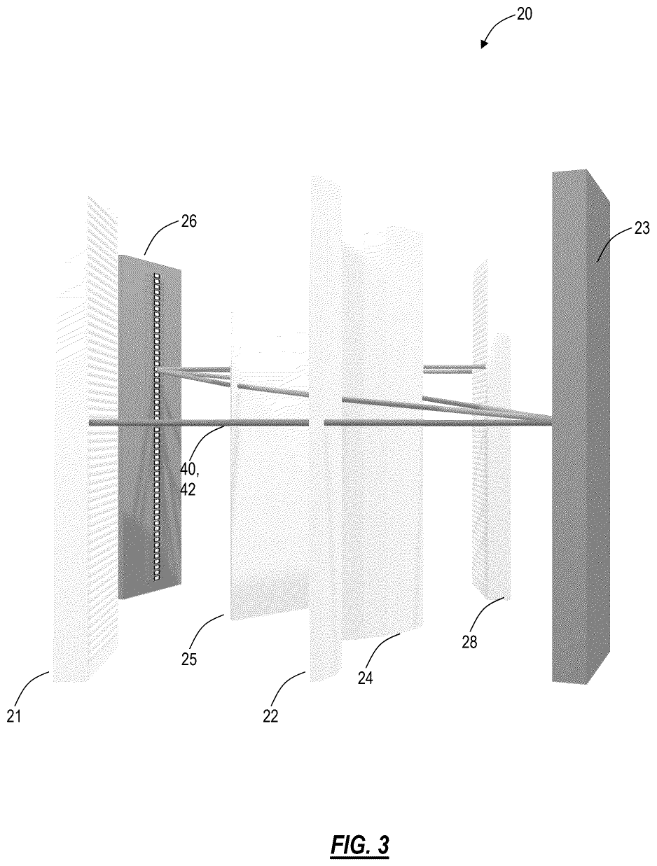

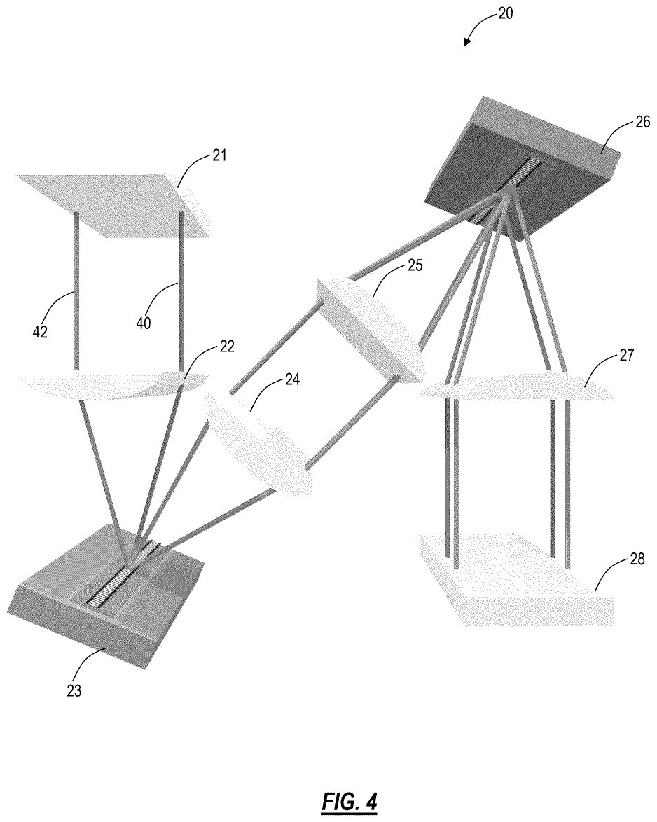

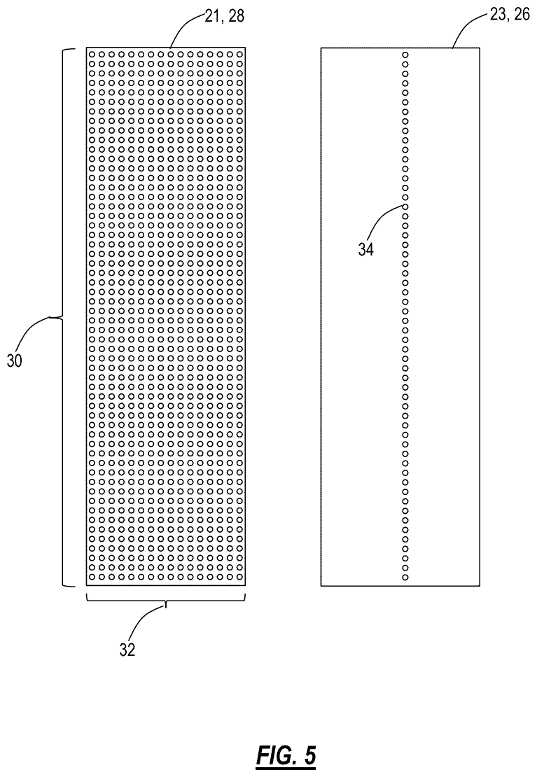

FIGS. 2 to 5 illustrate various views of an example ganged OCS 20 utilizing angular multiplexing to combine multiple optical signals, such as from PSM optical transceivers. The ganged OCS 20 includes an input array 21, a first multiplexing lens 22, a first switching plane 23, a second multiplexing lens 24, a third multiplexing lens 25, a second switching plane 26, a fourth multiplexing lens 27, and an output array 28. In this example, there are 56 vertical rows 30 on the input array 21 and the output array 28, with 16 ports 32 in each row 30, e.g., for a single PSM16 optical device 10. Those skilled in the art will recognize the values for the OCS 20 presented herein are for illustrative purposes and other values are also contemplated. The second multiplexing lens 24 and the third multiplexing lens 25 are called multiplexing lenses and this can also mean image transfer lenses.

The input array 21 includes lenses and fibers arranged in a 56 vertical by 16 horizontal configuration. The 56 vertical 30 rows are the independent devices 10 while the 16 ports 32 of each row are the PSM channels of each device 10. The input array 21 is shown with two light rays 40, 42 exiting the edge elements of one of the rows 30. In operation, all 16 of these lenses would be producing light for each device 10 which is connected for up to 896 light beams, in this example. Only two are shown here for clarity. The dimensions are also only for illustration.

The first multiplexing lens 22 is a cylindrical lens which multiplexes the PSM channels onto their one corresponding first switching element. A cylindrical lens performs angular multiplexing by focusing light in only one dimension, creating a line focus rather than a point focus. In the context of optical switching with angular multiplexing, the cylindrical lens serves a crucial role in combining multiple optical channels into a single switching point. The lens 22 accepts multiple input beams from all ports 32 in a row 30, each entering at a distinct spatial position, and focuses them to converge at a single point, i.e., a switching element 34. The transformation that the lens 22 is performing is position or spatial multiplexing to angle multiplexing. One could state “each entering at a distinct spatial position.” These beams maintain their angular relationships while being compressed in one dimension, allowing a single switching element to manipulate multiple channels simultaneously. The key advantage of this approach is that it enables multiple optical paths to be controlled by a single switching element while preserving the ability to separate them again at the output. The cylindrical lens's unique focusing properties maintain the spatial separation of the beams in one axis while focusing them in the perpendicular axis. When combined with a corresponding output cylindrical lens system, this allows for efficient demultiplexing of the signals back into separate channels. This technique is particularly valuable in PSM applications, as it can handle multiple parallel channels without requiring individual switching elements for each fiber, significantly reducing the complexity and size of optical circuit switches while maintaining the ability to route multiple channels simultaneously.

The first switching plane 23 includes a vertical array of 56 switching elements 34, e.g., MEMS-based switching mirrors. The mirrors have a tilt axis which can deflect the light in the vertical direction to any row 30. Tilting the MEMS mirror allows the light to propagate to any of the 56 corresponding MEMS element on the second switching plane.

The second multiplexing lens 24 is a second cylindrical lens which redirects the PSM channels into a straight path to allow for the extra propagation distance. This is part of the lensing and aperture design of this part of the optical path. The lensing arrangement in the OCS 20 uses 4 identical cylindrical lenses 22, 24, 25, 27, however, it should be noted that the middle two lenses 24, 25 could be replaced with a single lens with a different size and focal length. The 4 identical mirror arrangement is shown here for clarity. Of course, the lens 22, 24, 25, 27 are cylindrical based on the geometry of the OCS 20, and those skilled in the art will recognize other types of lens may also be used in different geometries.

The third multiplexing lens 25 is a third cylindrical lens which multiplexes the PSM channels onto their one corresponding second switching element in the second switching plane 26. The second switching plane 26 of switching elements 34 is arranged in the same way as the first switching plane 23. The mirrors are tilted to propagate the light directly to the output selected.

The fourth multiplexing lens 27 is a fourth cylindrical lens which demultiplexes the PSM channels onto their corresponding outputs. The output array 28 of lenses and fibers arranged in the same way as the input array 21.

The diagram shows two possible positions of the input mirror aligned to the light rays 40, 42. The first position is the “zero angle” position of the MEMS elements and maintains the light in the same plane vertically as shown by the reflected light rays 40, 42. These light rays 40, 42 propagate to the second switching element 26 which is also set to the “zero angle” position and therefore redirects the beams to the outputs shown by the light rays 40, 42. The second possible switching position shown has the first MEMS mirror tilted in the vertical direction such that the light propagates with an upward angle. This is shown by rays 44, 46 in the diagram. These rays 44, 46 strike a mirror ten rows above the “zero angle” position. This mirror on the output plane is then angled such that the beams propagate horizontally form that point to the output row ten rows above the “zero angle” position. It should be noted that in order to couple efficiently, the light propagating toward the output must be at the same angle as light would normally exit should that port be used as an input. This is the usual constraint for guided wave to free space transitions.

### Ganged OCS Size

The size of the OCS 20 is limited only by the trade-offs as follows:
(1) The propagation distance achievable for the wavelength of light being used and the size and quality of the collimators as dictated by the physics of Gaussian beam propagation and the Rayleigh length,
(2) The tilt angles which the MEMS switching elements are capable of,
(3) The limits on the manufacturing sizes of the mirrors and lens arrays,
(4) Manufacturing tolerances on placing the optical elements which can be mitigated through active optical alignment, and
(5) Tolerances for temperature and drift over the lifetime of the device.

In some design configurations it is possible that only a single lens element is required to relay between the switching elements 23, 26, which could replace the multiplexing lens 24, 25 with a single element. In another embodiment, the lens 22, 24, 25, 27 could be Prismatic lens rather than pure cylindrical.

It is also possible to provide an extra degree of tilt on the mirrors which need not be accurately calibrated. This extra tilt axis is provided to enable hitless switching by directing the light at an angle which cannot couple to any input or output fibers regardless of the angle of the mirrors in the switching plane.

### Alternate Angular Multiplexing Arrangement

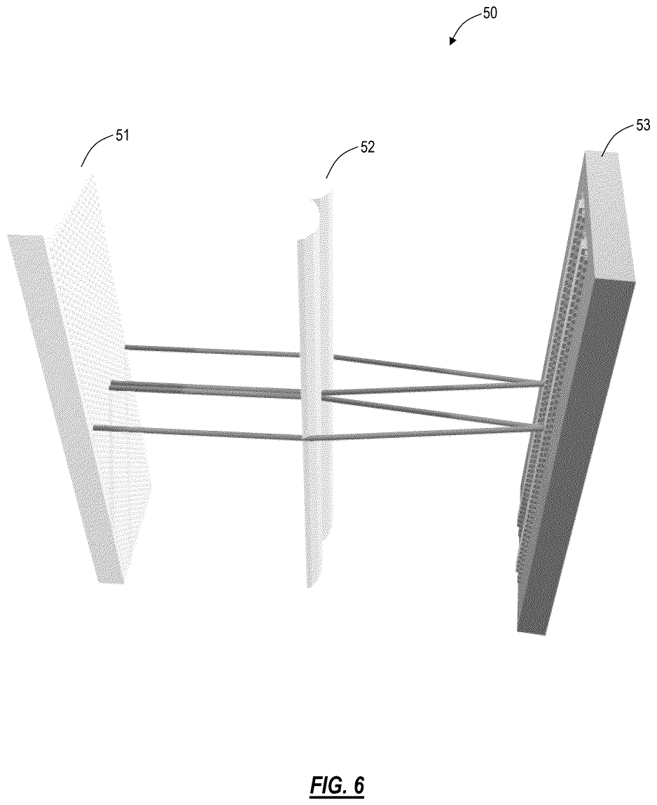

The OCS 20 illustrated an angular multiplexing arrangement with all ports 32 in a row 30 being multiplexed to a single switching element 34. Of course, various other approaches are possible. FIG. 6 illustrates a system 50 with an array 51, lens 52, and a switching element 53, with a different angular multiplexing arrangement from the OCS 20. For example, the system 50 shows one of the input/output arrays with the corresponding lenses and switching element array. In this case there are 2 PSM groups per row in the array and two vertical arrays of switching elements. The cylindrical lens has also been arranged such that there are two cylindrical sections each corresponding to the PSM group in the rows. The remainder of the device has similarly designed cylindrical lens, switching elements and input/output arrangements.

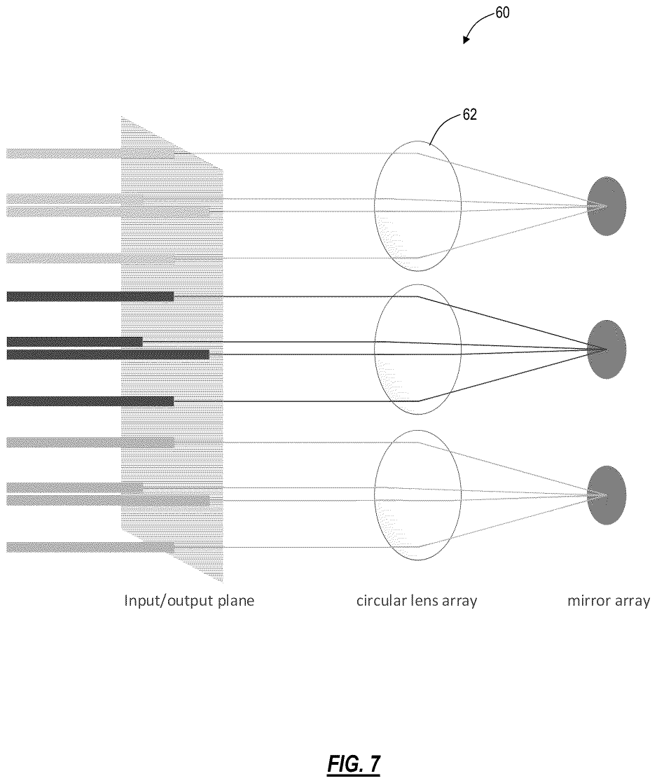

Further to this arrangement, groups of vertically and horizontally arranged inputs/outputs could address single lenses which focus onto a single mirror. FIG. 7 illustrates a system 60 with circular lens 62 for angular multiplexing of vertically and horizontally arranged inputs/outputs. For example, sets of circularly arranged fibers which hit a circular lens 62. All of these ganged inputs/outputs address a single mirror in the array. These inputs/outputs could be provided such that some are individual cores of a single fiber as in multicore fibers.

The various OCSs organize collimators in optical switching by implementing a two-dimensional grid arrangement rather than traditional linear arrays. In this design, collimators that are designated for co-switching are grouped into 4×4 square tiles (though triangular or hexagonal patterns are also possible), which are then arranged in a 7×8 pattern, creating 56 tiles that accommodate a total of 896 collimators. This arrangement transforms what would traditionally be a 56-row linear array with 16 collimators per row into a more compact and efficient 2D configuration. The design replaces conventional cylindrical lenses with square-aperture spherical lenses, which provide focusing capabilities for each 4×4 grouping. This spherical lens arrangement offers improved optical performance and more efficient space utilization compared to cylindrical lenses, as it can handle focusing in both dimensions simultaneously. The 2D tiled pattern maintains compatibility with the original design specifications while providing additional benefits in terms of optical alignment, mechanical stability, and overall system compactness. This approach is particularly valuable in high-density optical switching applications, such as those using PSM16 modules, where managing large numbers of parallel optical channels efficiently is crucial.

In optical switches, ports and collimators serve complementary but distinct roles. A port is the physical input/output interface where optical fibers connect to the switch, typically appearing as fiber connectors like LC or MPO. In contrast, a collimator is the internal optical component that transforms diverging light from the input fiber into parallel beams (or vice versa), enabling efficient switch operation. While each port typically corresponds to a collimator, their functions differ-ports provide the external connection points, while collimators handle the critical optical beam manipulation inside the switch, including beam collimation, maintaining beam quality, and ensuring efficient coupling back into output fibers. This distinction is important in switch specifications, where port count indicates external connectivity capacity, while collimator count refers to the internal optical components managing the light beams. In a physical implementation, a cable with multiple fibers will connect to the input and output arrays 21, 28, such as with a Multi-fiber Push On (MPO) connector.

Also, of note, the terms wavelengths, beams, and channels can be used herein interchangeably, namely optical signals between switched via the OCS 20. In an embodiment, all of the channels can use the same wavelength, e.g., 1310 nm in the PMS optical device 10. Note, these channels propagate in a free space region between the input array 21 and the output array 28, but are together on the switching elements 34, but only at this point and separated all other points.

### Use Case

ML/AI has exploded in recent years, particularly the so-called LLMs. These models ingest vast datasets on the order of 10s of Terabytes and 100's of billions of parameters which need to be determined through training. The training of such a model cannot be achieved in a single tensor processing unit (TPU) or GPU (either referred to as a GPU from here forward) and is therefore parallelized across as many GPUs as practical. The parallelization can be done in multiple ways including data-parallel, where each GPU or GPU cluster works on a portion of the data, or model-parallel where each GPU or GPU cluster works on a portion of the parameter space. In both cases, clustering of GPUs is critical in speeding up this process where multiple GPUs work together sharing memory space which is distributed across the multiple GPU elements. This requires low latency and high bandwidth communications between the GPUs and is provided through a combination of direct connections, board to board connections, and rack to rack connections. Usually there are networking switches employed which provide the mesh of connectivity between all GPUs.

However, traffic patterns between GPUs can be predictable for different types of training jobs. In some cases, this is due to the algorithms used for solving the training problems which require certain pairs of GPUs to communicate with each other more often than other pairs. Other times this is because of the way the models are parallelized or even different users requiring a different size set of GPUs to be clustered for the training requirements. Regardless, it has been shown that it is advantageous to use the network switches to reconfigure the topology of the interconnection between GPUs.

As a result, it has been shown that there is an advantage to introducing OCS elements to the data center network when there is a need to use optical connections. The need to switch from electrical cables to optical fiber is driven by the bandwidth-distance product. Given the speed of interconnects today, which are on the order of 100s of Gbps, this requires optical connections for distances which span rack to rack, while on board, board to board and intra-rack remain electrical connections. The conversion to optical is expected to continue to shorter distances as the technology matures in this application and the speed of communications continues to increase.

Many of today's optical pluggable transponders lend themselves easily to OCSs where each plug has one pair of fibers, and all of the data traffic is modulated onto either a single optical carrier or a few optical carriers multiplexed onto this single pair. It is also possible to use a single fiber bidirectionally to minimize the number of OCS ports which are needed, either one port per transponder or one pair of ports per transponder. However, as total interconnect speeds continue to grow, there is a drive toward sharing optical infrastructure like lasers to drive cost down when using multiple parallel lanes in a single transponder. This results in PSM optical device 10 becoming more common in the industry and standards. These PSM optical device 10 have multiple pairs of fibers which carry a single source of traffic. The use of PSM optics with an OCS provides an opportunity for simplification in that one wishes to switch all fibers from a single transponder as a unit.

### Other Applications Besides PSM

While this OCS 20 has been described with PSM optics, it is possible to use in other applications besides PSM, to reduce the number of switching elements. That is, the ganged switch is useful even with different modems but assumes that one needs same topology across several switching planes. Also, while described herein with switching all channels from a single PSM optical device 10, it is also possible that a switched grouped could be from multiple PSM optical devices 10. For example, lane 1 from a 16×XCVR (transceiver) forms group 1, lane 2 from the same 16×XCVR forms group 2, etc.

Also, the OCS 20 can be used with other types of radio frequency (RF) signals, besides optical. For example, the OCS 20 can used with satellite communications such that a local group of satellites beams signals at an angle towards a single mirror pixel on an OCS satellite. Or land-based towers doing similar. Or racks on a datacenter floor aiming beams at a ceiling-mounted OCS. In all these cases, the input/output array is large and individual collimator lenses might make more sense than a single cylindrical lens.

### a Ganged Optical Circuit Switch

In an embodiment, a ganged optical circuit switch 20 includes an input array 21 and an output array 28 each having a set of ports; a first switching plane 23 and a second switching plane 26 disposed between the input array 21 and the output array 28, each having a plurality of switching elements 34; and one or more multiplexing lens 22, 24, 25, 27 located between the input array 21 and the output array 28, configured to perform angular multiplexing of a group of the set of ports where all channels from the group are on a single switching element of the plurality of switching elements 34. The group of the set of ports can correspond to a parallel single mode (PSM) optical device 10. In an embodiment, the input array 21 and the output array 28 includes the set of ports in rows 30 and columns 32. Here, a row of the rows 30 is angularly multiplexed onto the single switching element 34 such that the row is switched to any of the rows 30 on the output array 28.

The plurality of switching elements 34 can be micro-electro-mechanical systems (MEMS) mirrors. The channels from each of the group are each switched via a given mirror of the MEMS mirror. As noted in FIGS. 2-4, the beams are angularly multiplexed by a given lens, and demultiplex after the MEMS mirror. Also, as noted in FIGS. 2-4, the ganged optical circuit switch 20 includes a free space region between the input array and the output array with each of the channels traversing the free space region separate except when angularly multiplexed via a lens onto the single switching element.

The one or more multiplexing lens 22, 24, 25, 27 include a first cylindrical lens 22, a second cylindrical lens 24, a third cylindrical lens 25, and a fourth cylindrical lens 27. The first cylindrical lens 22 is located between the input array 21 and the first switching plane 23; the second cylindrical lens 24 and the third cylindrical lens 25 are located between the first switching plane 23 and the second switching plane 26; and the fourth cylindrical lens 27 is located between the second switching plane 26 and the output array 28. Here, each of the one or more multiplexing lenses 22, 24, 25, 27 is an identical lens. Again, the one or more multiplexing lenses 24, 25 can be combined in a different lens. Also, there can be implementations that reduce the number of multiplexing lenses 22, 24, 25, 27, e.g., the input array 21 can be physically constructed to perform the angular multiplexing, without the need for the lens 22.

Note, the previous example was described with the multiplexing lenses 22, 24, 25, 27, and in some embodiments, the number of lenses can be reduced. For example, the input array 21 can be configured to perform a first stage of the angular multiplexing of the group, so that there is no lens 22 between the input array 21 and the first switching element 23. That is, the input array 21 and the output array 28 are shown in this example as straight, but it is possible for curved implementations, to remove the lenses 22, 27. In other embodiments, the lens 22 could be integrated with the input array 21, and the lens 27 could be integrated with the output array 28.

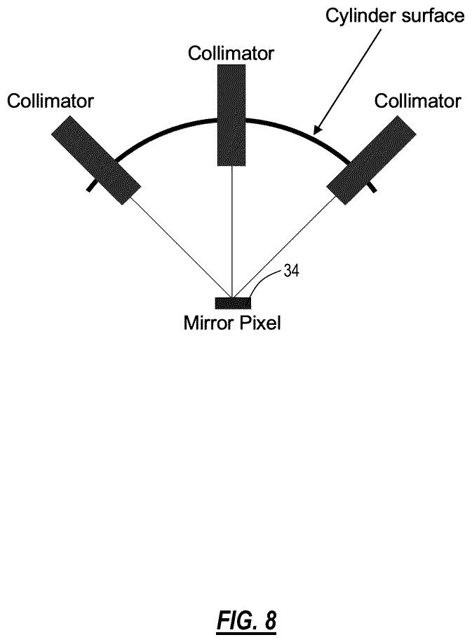

FIG. 8 illustrates a diagram of an implementation of a curved input array 21 output array 28. Here, there is a curved surface enabling the first and last stages of the angular multiplexing in the OCS 20.

### Process

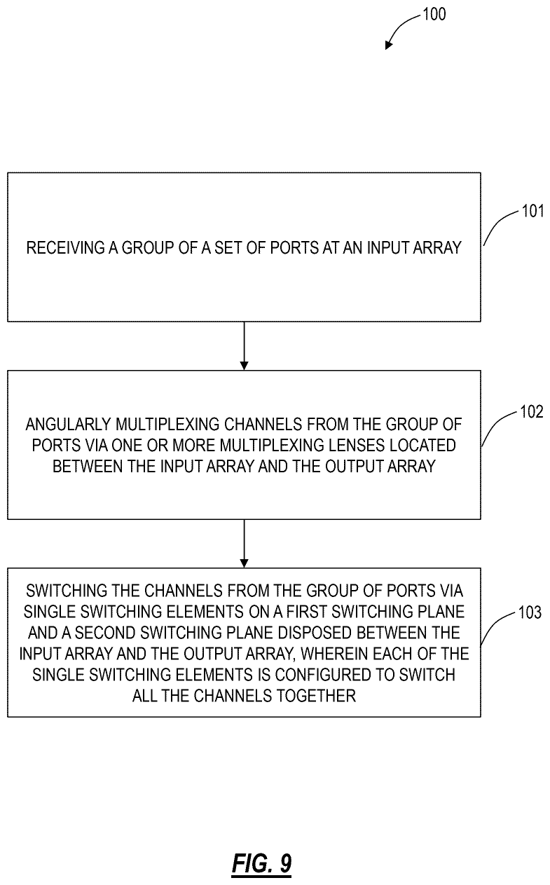

FIG. 9 illustrates a flowchart of a process 100 of operating a ganged optical circuit switch. The process 100 includes receiving a group of a set of ports at an input array (step 101); angularly multiplexing from the group of ports via one or more multiplexing lenses located between the input array and the output array (step 102); and switching the channels from the group of ports via single switching elements on a first switching plane and a second switching plane disposed between the input array and the output array, wherein each of the single switching elements is configured to switch all the channels together (step 103).

### CONCLUSION

Note, there are various embodiments disclosed herein with specific geometries and arrangement of components. Those skilled in the art will appreciate any approach that uses angular multiplexing to focus multiple channels on a single switching element is contemplated herein.

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner-whether collectively, in subsets, or individually-thereby broadening the range of potential embodiments.

What is claimed is:

1. A ganged optical circuit switch comprising:
an input array and an output array each having a set of ports;
a first switching plane and a second switching plane disposed between the input array and the output array, each having a plurality of switching elements; and
one or more multiplexing lenses located between the input array and the output array, configured to perform angular multiplexing of a group of the set of ports where all channels from the group are on a single switching element of the plurality of switching elements.

2. The ganged optical circuit switch of claim 1, wherein the input array and the output array includes the set of ports in rows and columns.

3. The ganged optical circuit switch of claim 2, wherein a row of the rows is angularly multiplexed onto the single switching element such that the row is switched to any of the rows on the output array.

4. The ganged optical circuit switch of claim 1, wherein the plurality of switching elements are micro-electro-mechanical systems (MEMS) mirrors.

5. The ganged optical circuit switch of claim 4, wherein the channels from a given group are each switched via a given mirror of the MEMS mirrors.

6. The ganged optical circuit switch of claim 1, further comprising
a free space region between the input array and the output array with each of the channels traversing the free space region separate except when angularly multiplexed via a lens onto the single switching element.

7. The ganged optical circuit switch of claim 1, wherein the one or more multiplexing lenses include a first cylindrical lens, a second cylindrical lens, a third cylindrical lens, and a fourth cylindrical lens.

8. The ganged optical circuit switch of claim 7, wherein
the first cylindrical lens is located between the input array and the first switching plane;
the second cylindrical lens and the third cylindrical lens are located between the first switching plane and the second switching plane; and
the fourth cylindrical lens is located between the second switching plane and the output array.

9. The ganged optical circuit switch of claim 1, wherein each of the one or more multiplexing lenses is an identical lens.

10. The ganged optical circuit switch of claim 1, wherein the input array is configured to perform a first stage of the angular multiplexing of the group, so that there is no lens between the input array and the first switching element.

11. A method of operating a ganged optical circuit switch comprising steps of:
receiving a group of a set of ports at an input array;
angularly multiplexing channels from the group of ports via one or more multiplexing lenses located between the input array and an output array; and
switching the channels from the group of ports via single switching elements on a first switching plane and a second switching plane disposed between the input array and the output array, wherein each of the single switching elements is configured to switch all the channels together.

12. The method of claim 11, wherein the input array and the output array includes the set of ports in rows and columns.

13. The method of claim 12, wherein a row of the rows is angularly multiplexed onto the single switching element such that the row is switched to any of the rows on the output array.

14. The method of claim 11, wherein the switching elements are micro-electro-mechanical systems (MEMS) mirrors.

15. The method of claim 14, wherein the channels from a given group are each switched via a given mirror of the MEMS mirrors.

16. The method of claim 11, wherein there is a free space region between the input array and the output array with each of the channels traversing the free space region separate except when angularly multiplexed via a lens onto the single switching elements.

17. The method of claim 11, wherein the one or more multiplexing lenses include a first cylindrical lens, a second cylindrical lens, a third cylindrical lens, and a fourth cylindrical lens.

18. The method of claim 17, wherein
the first cylindrical lens is located between the input array and the first switching plane;
the second cylindrical lens and the third cylindrical lens are located between the first switching plane and the second switching plane; and
the fourth cylindrical lens is located between the second switching plane and the output array.

19. The method of claim 11, wherein each of the one or more multiplexing lenses is an identical lens.

20. The method of claim 11, wherein the input array is configured to perform a first stage of the angular multiplexing of the group, so that there is no lens between the input array and the first switching element.
